(19) United States
(12) Patent Application Publication
(10) Pub. No.: US 2026/0012469 A1
(43) Pub. Date: Jan. 8, 2026

(54) INDUSTRIAL CONTROL AUDIT METHOD AND APPARATUS BASED ON INDUSTRIAL INTERNET

(71) Applicant: BENXI IRON AND STEEL (GROUP) INFORMATION AUTOMATION CO., LTD., Liaoning (CN)

(72) Inventors: Changhao LV, Liaoning (CN); Gang TIAN, Liaoning (CN); Kai ZHAN, Liaoning (CN); Shuai ZHANG, Liaoning (CN); Yufan CUI, Liaoning (CN); Xueyou ZHAO, Liaoning (CN)

(21) Appl. No.: 19/277,592

(22) Filed: Jul. 23, 2025

Related U.S. Application Data
(63) Continuation-in-part of application No. PCT/CN2024/137877, filed on Dec. 9, 2024.

(30) Foreign Application Priority Data
Jul. 3, 2024 (CN) 202410882111.3

(51) Int. Cl. H04L 9/40; G05B 19/418

(52) U.S. Cl. CPC H04L 63/1416; G05B 19/4186; H04L 63/1425

(57) ABSTRACT

An industrial control audit method and apparatus based on Industrial Internet determine a protocol rule template corresponding to industrial control protocol data based on a similarity between the protocol data and the protocol rule templates of various industrial control protocols in a protocol database; parse control information of the protocol data based on the corresponding template; determine a first audit result based on the control information, complete message data, and data area message data of the protocol data; determine a second audit result based on statistical features of network traffic per unit time in network behavior data, and/or based on differences between current and historical running program information in the network behavior data; and evaluate a severity of network security events based on the first and the second audit results to obtain a security evaluation for a target audit time period, enabling prompt and accurate detection of such events.

### CROSS-REFERENCE TO RELATED APPLICATIONS

The present disclosure claims the benefit of priority to Chinese Patent Application No. 2024108821113, filed with the China National Intellectual Property Administration on Jul. 3, 2024 and entitled “INDUSTRIAL CONTROL AUDIT METHOD AND APPARATUS BASED ON INDUSTRIAL INTERNET”, the entire content of which is incorporated herein by reference.

### TECHNICAL FIELD

The present disclosure relates to the field of network data auditing technology, and particularly relates to an industrial control audit method and an apparatus based on the Industrial Internet.

### BACKGROUND

With the rise of the concept of Industry 4.0 and the introduction of Made in China 2025, the integration of the Industrial Internet and information networks has been accelerating. Traditional network communication technology has been widely applied in industrial control networks. The Industrial Internet is evolving towards comprehensive interconnection among humans, machines, and objects, gradually transitioning from the original human-centric interaction paradigm. This transformation not only extends the functions and boundaries of the existing cyberspace, but also disrupts the traditionally closed architecture of the industrial control system. At various levels of the Industrial Internet, including the control layer, device layer, and network layer, security issues have become increasingly prominent, and security risks continue to accumulate, resulting in a complex security landscape.

Specifically, with the emergence of hacker conferences, white-hat communities, and open source communities, methods for attacking the industrial control system have become increasingly accessible. Security vulnerabilities and corresponding exploitation techniques targeting a large number of industrial control system software and hardware devices can be obtained through public or semi-public channels. This significantly increases the risk of attacks against industrial control networks. This trend poses unprecedented challenges to the security of the industrial control system. The current manual audit methods can no longer meet the demands of modern applications, and there is a pressing need for more comprehensive and efficient network security auditing strategies.

### SUMMARY

An industrial control audit method based on the Industrial Internet includes:
acquiring industrial control protocol data and network behavior data within a target audit time period;
determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; and determining a first audit result based on the control information, complete message data, and data area message data of the industrial control protocol data;
determining a second audit result based on statistical features of network traffic per unit time in the network behavior data, and/or based on differences between current running program information and historical running program information in the network behavior data; and
evaluating a severity level of network security events based on the first audit result and the second audit result to obtain a network security evaluation result for the target audit time period.

An industrial control audit apparatus based on the Industrial Internet includes:
a data acquisition unit, configured to acquire industrial control protocol data and network behavior data within a target audit time period;
a first audit unit, configured to determine, based on a similarity between the industrial control protocol data and protocol rule templates of various industrial control protocols in a protocol database, a protocol rule template corresponding to the industrial control protocol data, to parse control information of the industrial control protocol data based on the protocol rule template corresponding to the industrial control protocol data, and to determine a first audit result based on the control information, complete message data, and data area message data of the industrial control protocol data;
a second audit unit, configured to determine a second audit result based on statistical features of network traffic per unit time in the network behavior data, and/or based on differences between current running program information and historical running program information in the network behavior data; and
a security evaluation unit, configured to evaluate a severity level of network security events based on the first audit result and the second audit result to obtain a network security evaluation result for the target audit time period.

An electronic device includes a memory, a processor, and a computer program stored on the memory and executable by the processor, where the processor, when executing the computer program, implements any of the industrial control audit methods based on the Industrial Internet as described above.

A non-transitory computer-readable storage medium stores a computer program, where the computer program, when executed by a processor, implements any of the industrial control audit methods based on the Industrial Internet as described above.

A computer program product includes a computer program, where the computer program, when executed by a processor, implements any of the industrial control audit methods based on the Industrial Internet as described above.

### BRIEF DESCRIPTION OF DRAWINGS

In order to more explicitly illustrate technical solutions of the present disclosure or the existing art, drawings required for descriptions of the embodiments or the existing art are briefly introduced below. It should be apparent that the drawings described below are merely some embodiments of the present disclosure, and that other drawings may also be derived by a person of ordinary skill in the art without creative effort based on these drawings.

FIG. 1 is a schematic flowchart of an industrial control audit method based on the Industrial Internet provided in the present disclosure.

FIG. 2 is a schematic flowchart of a method for determining a first audit result provided in the present disclosure.

FIG. 3 is a schematic flowchart of a similarity calculation method provided in the present disclosure.

FIG. 4 is a schematic diagram of a structure of an industrial control audit apparatus based on the Industrial Internet provided in the present disclosure.

FIG. 5 is a schematic diagram of a structure of an electronic device provided in the present disclosure.

### DETAILED DESCRIPTION OF THE EMBODIMENTS

To make the objectives, technical solutions, and advantages of the present disclosure clearer, the technical solutions of the present disclosure will be clearly and completely described below with reference to the drawings in the present disclosure. It is apparent that the embodiments described are only some embodiments of the present disclosure, rather than all embodiments. All other embodiments obtained by those of ordinary skill in the art based on the embodiments of the present disclosure without any creative effort shall fall within the protection scope of the present disclosure.

The present disclosure provides an industrial control audit method and apparatus based on the Industrial Internet, configured to address the deficiencies in the existing art related to insufficient accuracy and efficiency of security audit in the industrial control system.

The present disclosure provides an industrial control audit method based on the Industrial Internet includes:
acquiring industrial control protocol data and network behavior data within a target audit time period;
determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; and determining a first audit result based on the control information, complete message data, and data area message data of the industrial control protocol data;
determining a second audit result based on statistical features of network traffic per unit time in the network behavior data, and/or based on differences between current running program information and historical running program information in the network behavior data; and
evaluating a severity level of network security events based on the first audit result and the second audit result to obtain a network security evaluation result for the target audit time period.

According to an industrial control audit method based on the Industrial Internet provided in the present disclosure, the determining a first audit result based on the control information, complete message data, and data area message data of the industrial control protocol data, includes:
determining, based on sample control information of sample industrial control protocol data labeled as normal and the control information of the industrial control protocol data, a control anomaly analysis result of the industrial control protocol data;
performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
determining the first audit result based on the control anomaly analysis result, the complete message anomaly analysis result, and the data area message anomaly analysis result of the industrial control protocol data.

According to an industrial control audit method based on the Industrial Internet provided in the present disclosure, a similarity between the industrial control protocol data and a protocol rule template of any type of industrial control protocol in a protocol database is determined based on the following steps:
determining all common subsequences and the longest common subsequence between the industrial control protocol data and the protocol rule template of the any type of industrial control protocol;
determining a difference factor based on sequence length of the longest common subsequence between the industrial control protocol data and the protocol rule template of the any type of industrial control protocol and the sequence lengths of the industrial control protocol data and the protocol rule template of the any type of industrial control protocol;
determining a sequence consistency factor based on a sum of the sequence lengths of all common subsequences between the industrial control protocol data and the protocol rule template of the any type of industrial control protocol, the sequence lengths of the industrial control protocol data and the protocol rule template of the any type of industrial control protocol, and the difference factor;
calculating an edit distance between the industrial control protocol data and the protocol rule template of the any type of industrial control protocol, and determining a sequence similarity factor based on the sequence length of the longest common subsequence between the industrial control protocol data and the protocol rule template of the any type of industrial control protocol and the edit distance between the industrial control protocol data and the protocol rule template of the any type of industrial control protocol; and
determining, based on the sequence consistency factor and the sequence similarity factor, the similarity between the industrial control protocol data and the protocol rule template of the any type of industrial control protocol.

According to an industrial control audit method based on the Industrial Internet provided in the present disclosure, protocol rule templates for various industrial control protocols in the protocol database are constructed based on the following steps:
feature extraction step: extracting textual features of each sample industrial control protocol data in the protocol database, where the textual features of any sample industrial control protocol data are determined based on term frequency and inverse document frequency of each segment in the any sample industrial control protocol data;
clustering step: clustering the sample industrial control protocol data based on a set value of the number of current clusters in combination with the textual features of each sample industrial control protocol data to obtain a plurality of current clusters and to acquire a cluster center of each cluster;
iteration step: performing cluster evaluation on the plurality of the current clusters to obtain a current cluster evaluation value; where if the current cluster evaluation value is greater than a currently optimal evaluation value, updating the current optimal evaluation value based on the current cluster evaluation value, and updating the current optimal clustering cluster and the cluster center of each current optimal clustering cluster based on the plurality of current clusters and their cluster centers; and increasing the set value of the number of the current clusters and repeating the clustering step until the set value of the number of the current clusters reaches a preset value; and
template determination step: determining the protocol rule templates for various industrial control protocols based on the cluster centers of the current optimal clustering clusters.

According to an industrial control audit method based on the Industrial Internet provided in the present disclosure, the determining a second audit result based on statistical features of network traffic per unit time in the network behavior data, and/or based on differences between current running program information and historical running program information in the network behavior data, includes:
determining a network traffic anomaly analysis result, based on statistical features of network traffic per unit time in the network behavior data, where the statistical features include a mean, variance, and quantile of the network traffic per unit time; and/or
determining, based on the current running program information and the historical running program information in a historical time period in the network behavior data, the current running program information that does not match the historical running program information as a suspected the target audit time period and on memory information of the suspected abnormal running program; and
determining the second audit result based on the network traffic anomaly analysis result and/or the running program anomaly analysis result.

According to an industrial control audit method based on the Industrial Internet provided in the present disclosure, after the determining a second audit result, the method further includes:
issuing, if either the network traffic anomaly analysis result or the running program anomaly analysis result indicates an anomaly, a network security alarm under the condition that power supply and network connection are not interrupted; and
issuing, if both the network traffic anomaly analysis result and the running program anomaly analysis result indicate anomalies, a network security alarm under the condition that the network connection is cut off while the power supply remains uninterrupted.

According to an industrial control audit method based on the Industrial Internet provided in the present disclosure, the evaluating a level of network security events based on the first audit result and the second audit result to obtain a network security evaluation result for the target audit time period, includes:
determining a third audit result based on the binding status of an IP address and a MAC address, the access relationship between at least two devices, and the devices present in the industrial control network during the target audit time period; and
evaluating a severity level of network security events based on the first audit result, the second audit result, and the third audit result to obtain a network security evaluation result for the target audit time period.

The present disclosure further provides an industrial control audit apparatus based on the Industrial Internet, including:
a data acquisition unit, configured to acquire industrial control protocol data and network behavior data within a target audit time period;
a first audit unit, configured to determine, based on a similarity between the industrial control protocol data and protocol rule templates of various industrial control protocols in a protocol database, a protocol rule template corresponding to the industrial control protocol data, to parse control information of the industrial control protocol data based on the protocol rule template corresponding to the industrial control protocol data, and to determine a first audit result based on the control information, complete message data, and data area message data of the industrial control protocol data;
a second audit unit, configured to determine a second audit result based on statistical features of network traffic per unit time in the network behavior data, and/or based on differences between current running program information and historical running program information in the network behavior data; and
a security evaluation unit, configured to evaluate a severity level of network security events based on the first audit result and the second audit result to obtain a network security evaluation result for the target audit time period.

The present disclosure further provides an electronic device, including a memory, a processor, and a computer program stored on the memory and executable by the processor, where the processor, when executing the computer program, implements any of the industrial control audit methods based on the Industrial Internet as described above.

The present disclosure further provides a non-transitory computer-readable storage medium storing a computer program, where the computer program, when executed by a processor, implements any of the industrial control audit methods based on the Industrial Internet as described above.

The present disclosure further provides a computer program product, including a computer program, where the computer program, when executed by a processor, implements any of the industrial control audit methods based on the Industrial Internet as described above.

The industrial control audit method and apparatus based on the Industrial Internet provided in the present disclosure determine a protocol rule template corresponding to the industrial control protocol data based on a similarity between the industrial control protocol data and the protocol rule templates of various industrial control protocols in a protocol database; parse control information of the industrial control protocol data based on the protocol rule template corresponding to the industrial control protocol data; determine a first audit result based on the control information, complete message data, and data area message data of the industrial control protocol data; determine a second audit result based on statistical features of network traffic per unit time in the network behavior data, and/or based on differences between current running program information and historical running program information in the network behavior data; and evaluate a severity level of network security events based on the first audit result and the second audit result to obtain a network security evaluation result for the target audit time period. By performing dual industrial control security audits on both the industrial control protocol data and the network behavior data, the disclosed method can promptly and accurately detect whether a network security event has occurred in the industrial control network, thereby significantly reducing the risk of the industrial control network being subjected to cyberattacks.

Embodiments of the present disclosure are described in further detail below with reference to the drawings.

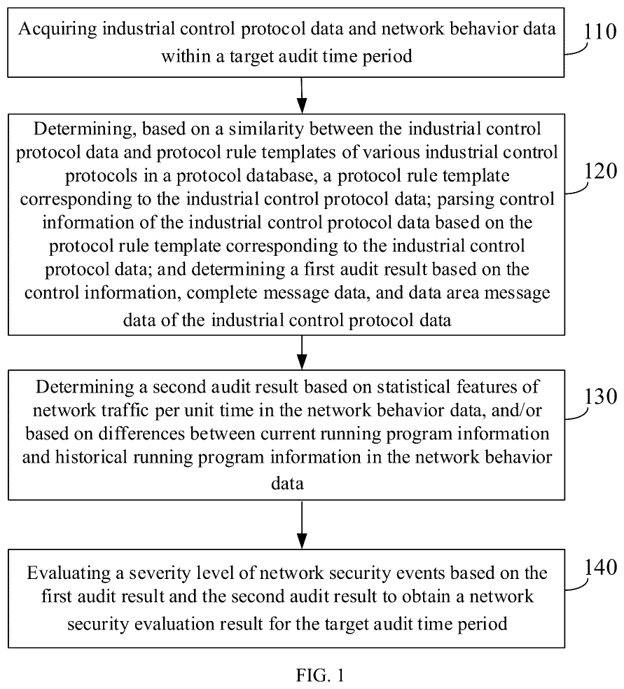

FIG. 1 is a schematic flowchart of an industrial control audit method based on the Industrial Internet provided in the present disclosure. As shown in FIG. 1, the method includes:
Step 110, acquiring industrial control protocol data and network behavior data within a target audit time period;
Step 120, determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; and determining a first audit result based on the control information, complete message data, and data area message data of the industrial control protocol data;
Step 130, determining a second audit result based on statistical features of network traffic per unit time in the network behavior data, and/or based on differences between current running program information and historical running program information in the network behavior data; and
Step 140, evaluating a severity level of network security events based on the first audit result and the second audit result to obtain a network security evaluation result for the target audit time period.

The industrial control protocol data and the network behavior data herein are two important types of data generated in an industrial control system (ICS). Specifically, the devices and controllers in the industrial control system typically communicate and interact through specific protocols, which are usually designed for the industrial control field. Therefore, the industrial control protocol data includes commands, data, status information, and other communications exchanged between devices, serving as the foundation for the proper operation and interaction of the control system. Since the industrial control system is typically deployed in a network environment, devices communicate with each other over the network. As a result, the network behavior data refers to data traffic generated by industrial control devices in the network, including communication between devices, transmission of control commands, and data transmission. The data can be captured and analyzed using network packet capture tools or network traffic monitoring devices. It can be seen that the industrial control protocol data and the network behavior data during the target audit time period are critical for the security audit and monitoring of the industrial control system. By analyzing the data, security risks, abnormal behaviors, and potential attacks in the system can be identified, thereby facilitating timely detection and response to security threats, and ensuring the safe and stable operation of the industrial control system.

Specifically, for the industrial control protocol data, the similarity between the industrial control protocol data and the protocol rule templates of various industrial control protocols in a pre-constructed protocol database can be calculated to determine the protocol rule template corresponding to the industrial control protocol data; the industrial control protocol data then can be parsed based on the protocol rule template corresponding to the industrial control protocol data to determine the control information of the industrial control protocol data, and subsequently, a first audit result can be determined based on the control information of the industrial control protocol data, the complete message data corresponding to the industrial control protocol data, and the data area message data (that is the message data of the data area). The control information of the industrial control protocol data includes control commands, control points, and control values. In some embodiments, if the similarity between the industrial control protocol data and the protocol rule templates of various industrial control protocols in the pre-constructed protocol database is relatively low, it is determined that the industrial control protocol data does not match any industrial control protocols formats, and the first audit result can be directly determined to be abnormal.

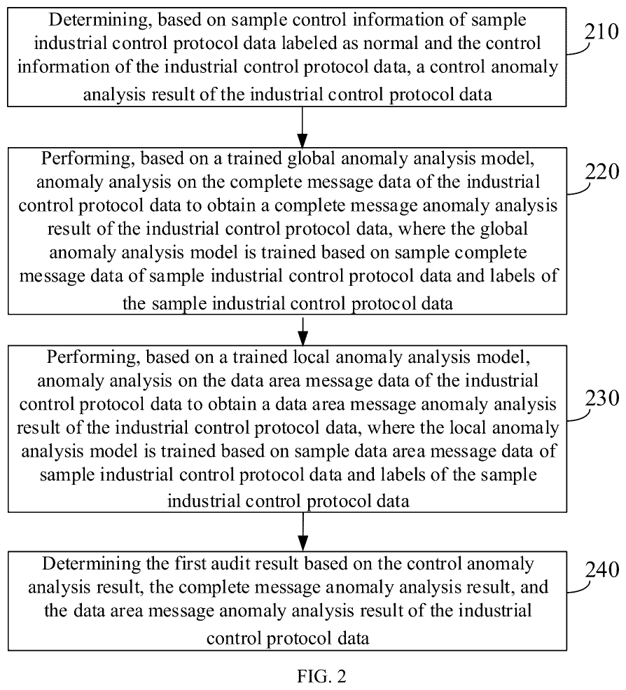

In some embodiments, as shown in FIG. 2, the first audit result can be determined through the following steps:
Step 210, determining, based on sample control information of sample industrial control protocol data labeled as normal and the control information of the industrial control protocol data, a control anomaly analysis result of the industrial control protocol data;
Step 220, performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
Step 230, performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
Step 240, determining the first audit result based on the control anomaly analysis result, the complete message anomaly analysis result, and the data area message anomaly analysis result of the industrial control protocol data.

Prior to performing an actual audit, sample industrial control protocol data generated during the normal operation of the device can be collected in advance. At this time, the sample industrial control protocol data is labeled as normal. Since the control information generated by devices operating stably in the industrial control system is also consistent, the control anomaly analysis result of the industrial control protocol data can be determined based on the sample control information of the sample industrial control protocol data labeled as normal and the control information of the industrial control protocol data to be audited. In some embodiments, if the control information of the industrial control protocol data to be audited does not appear in the sample control information of the sample industrial control protocol data labeled as normal, the control anomaly analysis result can be determined to be abnormal.

On the other hand, anomaly analysis can also be performed on the complete message data of the industrial control protocol data based on the trained global anomaly analysis model, and simultaneously, anomaly analysis can be performed on the data area message data of the industrial control protocol data based on the trained local anomaly analysis model, thereby obtaining the complete message anomaly analysis result and the data area message anomaly analysis result of the industrial control protocol data respectively. By analyzing the complete message data and the data area message data of the industrial control protocol data respectively, anomaly detection of the message data can be performed from two directions: global information of the complete message itself and local information of the data area message data. Subsequently, the first audit result can be comprehensively determined based on the control anomaly analysis result, the complete message anomaly analysis result, and the data area message anomaly analysis result of the industrial control protocol data. It can be seen that by further detecting the anomaly of the industrial control protocol data from the perspective of the message data, the control anomaly analysis result from the control information perspective as described above can be supplemented, thereby improving the accuracy of anomaly detection of the industrial control protocol data. It should be noted that the global anomaly analysis model and the local anomaly analysis model can be constructed based on neural networks (such as autoencoders and long short-term memory networks), and can be trained based on the sample complete message data of the sample industrial control protocol data and the labels of the sample industrial control protocol data, as well as the sample data area message data of the sample industrial control protocol data and the labels of the sample industrial control protocol data.

To accurately analyze anomalies of industrial control protocol data, correct parsing of the industrial control protocol data is the core, and the key to correctly parsing the industrial control protocol data lies in accurately determining the protocol rule template corresponding to the industrial control protocol data. Therefore, in order to ensure the accuracy of anomaly analysis of the industrial control protocol data, an efficient and accurate similarity measurement method is proposed to determine the similarity between the industrial control protocol data and the protocol rule templates of various industrial control protocols in a protocol database. The precision and efficiency of similarity measurement are improved by combining character position similarity, character sequence and structural similarity, and continuity and consistency between texts.

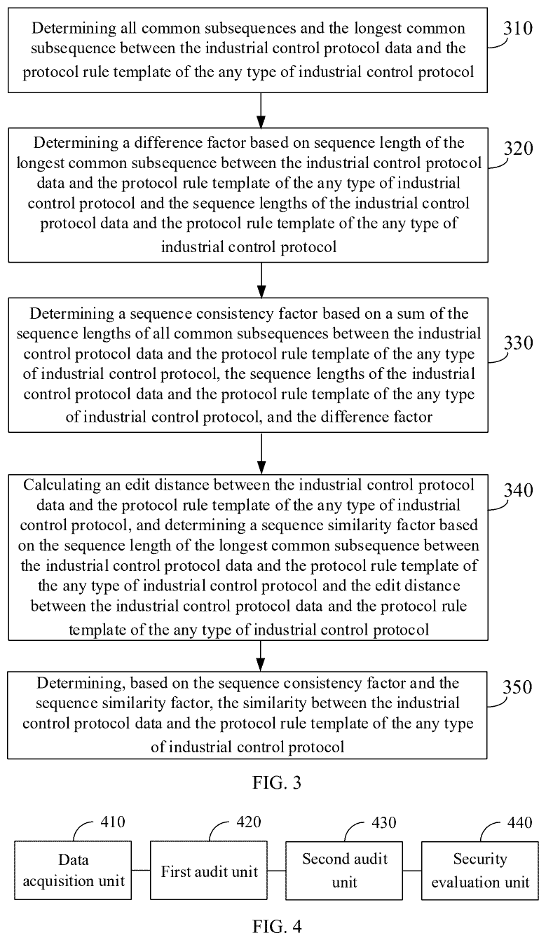

Specifically, as shown in FIG. 3, the similarity between the industrial control protocol data and the protocol rule template of any type of industrial control protocol in the protocol database can be determined through the following steps:
Step 310, determining all common subsequences and the longest common subsequence between the industrial control protocol data and the protocol rule template of the any type of industrial control protocol;
Step 320, determining a difference factor based on sequence length of the longest common subsequence between the industrial control protocol data and the protocol rule template of the any type of industrial control protocol and the sequence lengths of the industrial control protocol data and the protocol rule template of the any type of industrial control protocol;
Step 330, determining a sequence consistency factor based on a sum of the sequence lengths of all common subsequences between the industrial control protocol data and the protocol rule template of the any type of industrial control protocol, the sequence lengths of the industrial control protocol data and the protocol rule template of the any type of industrial control protocol, and the difference factor;
Step 340, calculating an edit distance between the industrial control protocol data and the protocol rule template of the any type of industrial control protocol, and determining a sequence similarity factor based on the sequence length of the longest common subsequence between the industrial control protocol data and the protocol rule template of the any type of industrial control protocol and the edit distance between the industrial control protocol data and the protocol rule template of the any type of industrial control protocol; and
Step 350, determining, based on the sequence consistency factor and the sequence similarity factor, the similarity between the industrial control protocol data and the protocol rule template of the any type of industrial control protocol.

At this point, all common subsequences between the industrial control protocol data and the protocol rule template of the any type of industrial control protocol, as well as the longest common subsequence therein, can be determined. The difference factor is determined based on the sequence length of the longest common subsequence between the industrial control protocol data and the protocol rule template of the corresponding industrial control protocol type, and on the respective sequence lengths of the industrial control protocol data and the protocol rule template of corresponding industrial control protocol type. The difference factor is configured to limit the repeated impact of the longest common subsequence and the common subsequences on the similarity. In some embodiments, the difference factor can be calculated using the following formula:

$$d = 1 - α \times {L}_{LCS} / ( p + q )$$

where, d is the difference factor, L_{LCS} is the sequence length of the longest common subsequence between the industrial control protocol data and the protocol rule template of the corresponding industrial control protocol type, p is the sequence length of the industrial control protocol data, q is the sequence length of each protocol rule template of the corresponding industrial control protocol type, and α is a first adjustment factor that can be preset.

Subsequently, the sequence consistency factor can be determined based on the sum of the sequence lengths of all common subsequences between the industrial control protocol data and the protocol rule template of the corresponding industrial control protocol type, the sequence lengths of the industrial control protocol data and the protocol rule template of the corresponding industrial control protocol type, and the above-calculated difference factor. The sequence consistency factor can reflect the impact of continuity and consistency on text similarity. In some embodiments, the sequence consistency factor can be calculated using the following formula:

$$suc = β \times d \times Sop ( D , T ) / ( p + q )$$

where, suc is the sequence consistency factor, Sop(D, T) is the sum of the sequence lengths of all common subsequences between the industrial control protocol data D and the protocol rule template T of the corresponding industrial control protocol type, and β is a second adjustment factor that can be preset.

The edit distance between the industrial control protocol data and the protocol rule template of the corresponding industrial control protocol type is calculated. The sequence similarity factor is determined based on the sequence length of the longest common subsequence between the industrial control protocol data and the protocol rule template of the corresponding industrial control protocol type and the edit distance between the industrial control protocol data and the protocol rule template of the corresponding industrial control protocol type. The sequence similarity factor herein comprehensively considers both the longest common subsequence and the edit distance between two texts, reflecting the similarity in character positions, character sequences, and structure between the two texts. In some embodiments, the sequence similarity factor can be calculated using the following formula:

$$sos = {L}_{LCS} + ( max ( p , q ) - {L}_{ED} )$$

where, sos is the sequence similarity factor, and L_{ED} is the edit distance between the industrial control protocol data and the protocol rule template of the corresponding industrial control protocol type.

Based on the above sequence consistency factor and the above sequence similarity factor, the similarity between the industrial control protocol data and the protocol rule template of the corresponding industrial control protocol type can be determined. For example, the similarity between the industrial control protocol data and the protocol rule template of the corresponding industrial control protocol type can be obtained by summing or performing a weighted sum of the above sequence consistency factor and the above sequence similarity factor.

In other embodiments, the protocol rule templates of various industrial control protocols in the protocol database can be constructed based on the following steps:
feature extraction step: extracting textual features of each sample industrial control protocol data in the protocol database, where the textual features of any sample industrial control protocol data are determined based on term frequency and inverse document frequency of each segment in the any sample industrial control protocol data;
clustering step: clustering the sample industrial control protocol data based on a set value of the number of current clusters in combination with the textual features of each sample industrial control protocol data to obtain a plurality of current clusters and to acquire a cluster center of each cluster;
iteration step: performing cluster evaluation on the plurality of the current clusters to obtain a current cluster evaluation value; where if the current cluster evaluation value is greater than a currently optimal evaluation value, updating the current optimal evaluation value based on the current cluster evaluation value, and updating the current optimal clustering cluster and the cluster center of each current optimal clustering cluster based on the plurality of current clusters and their cluster centers; and increasing the set value of the number of the current clusters and repeating the clustering step until the set value of the number of the current clusters reaches a preset value; and
template determination step: determining the protocol rule templates for various industrial control protocols based on the cluster centers of the current optimal clustering clusters.

Specifically, in the feature extraction step, the term frequency (TF) and inverse document frequency (IDF) of each segment in each sample industrial control protocol data (the segments can be obtained by dividing the sample industrial control protocol data into multiple segments based on a predefined rule) can be extracted, and textual features of each sample industrial control protocol data are extracted based on the TF-IDF method. For any sample industrial control protocol data, when determining the term frequency and inverse document frequency of each segment in the sample industrial control protocol data, the ratio of the number of occurrences of any segment in the sample industrial control protocol data to the total number of segments in the sample industrial control protocol data can be taken as the term frequency of a segment; and the logarithm of the ratio of the total number of the sample industrial control protocol data in the protocol database to the number of the sample industrial control protocol data containing the any segment in the protocol database can be taken as the inverse document frequency of the segment. Then, the product of the term frequency and the inverse document frequency of the any segment is taken as the feature value of the segment, and a vector composed of the feature values of all segments in the any sample industrial control protocol data constitutes the textual feature of the sample industrial control protocol data.

Subsequently, clustering can be performed iteratively and the cluster center of each cluster determined. In a round of iteration, a clustering algorithm (such as the KMeans algorithm) can be applied to cluster each sample industrial control protocol data based on the set value (initially set to 1) of the number of current clusters in combined with the textual features of each sample industrial control protocol data to obtain a plurality of current clusters and acquire the cluster center of each cluster. For any cluster, the sample industrial control protocol data with the smallest sum of edit distances to the textual features of other sample industrial control protocol data in the cluster can be acquired as the cluster center of the cluster. Subsequently, cluster evaluation is performed on the plurality of current clusters to obtain the current cluster evaluation value. Here, the current cluster evaluation value can be determined based on a silhouette coefficient. If the current cluster evaluation value is greater than the current optimal evaluation value (initially being 0), the current optimal evaluation value is updated based on the current cluster evaluation value, and the current optimal clustering cluster and the cluster center (initially, the cluster center of the current optimal clustering cluster and each current optimal clustering cluster is empty) of each current optimal clustering cluster are updated based on the plurality of current clusters and their cluster centers. If the set value of the number of current clusters has reached a preset value, the iteration process is terminated; otherwise, the set value of the number of the current clusters is increased (for example, by 1), and the next round of iteration process is executed to perform the above clustering step again. After the iteration is completed, the protocol rule templates of various industrial control protocols can be determined based on the cluster centers of the current optimal clustering clusters, thereby improving the efficiency of extracting the protocol rule templates of various industrial control protocols.

For the network behavior data, the second audit result can be determined based on the statistical features of the network traffic per unit time in the network behavior data, and/or based on the differences between the current running program information and the historical running program information in the network behavior data. Specifically, the network behavior data can include at least one of the network traffic per unit time and the current running program information per unit time. The anomaly analysis can be performed based on the statistical features of the network traffic per unit time in the network behavior data, or based on the differences between the current running program information and the historical running program information in the network behavior data. Alternatively, the anomaly analysis can also be performed by combining both the statistical features of the network traffic per unit time in the network behavior data and the differences between the current running program information and the historical running program information in the network behavior data. The embodiments of the present disclosure are not limited to any particular implementation.

In some embodiments, the statistical features of the network traffic per unit time in the network behavior data can include a mean, variance, and quantile of the network traffic per unit time. The network traffic anomaly analysis result can be determined by comparing the statistical features of the network traffic per unit time in the network behavior data with a preset threshold range. If the statistical features of any network traffic per unit time in the network behavior data fall outside the preset threshold range, the network traffic anomaly analysis result can be determined to be abnormal.

In addition, based on current running program information and historical running program information in a historical time period in the network behavior data, the current running program information in the network behavior data that does not match the historical running program information is determined as a suspected abnormal running program, that is, the suspected abnormal running program has not appeared in the historical time period. Based on the number of executions of the suspected abnormal running program during each unit time within the target audit time period, and on memory information of the suspected abnormal running program, a running program anomaly analysis result can be determined. Specifically, if the number of executions of the suspected abnormal running program during each unit time within a preset length period increases, the running program anomaly analysis result can be determined to be abnormal. Otherwise, the memory information of the suspected abnormal running program can be acquired through a debugger, and the running program anomaly analysis result can be determined based on the memory information of the suspected abnormal running program.

Based on the above network traffic anomaly analysis result and/or the running program anomaly analysis result, a second audit result can be determined. In some embodiments, after the second audit result is determined, corresponding handling measures can be taken. Specifically, if either the network traffic anomaly analysis result or the running program anomaly analysis result indicates an anomaly, a network security alarm is issued under the condition that power supply and network connection are not interrupted, allowing technicians to remove malicious software and fix vulnerabilities; and if both the network traffic anomaly analysis result and the running program anomaly analysis result indicate anomalies, a network security alarm is issued under the condition that the network connection is cut off while the power supply remains uninterrupted, allowing technicians to remove malicious software and fix vulnerabilities.

By comprehensively analyzing the above first audit result and the above second audit result, a security level of a network security event can be evaluated based on a preset rule, thereby obtaining a network security evaluation result for the target audit time period, and then the network security evaluation result can be sent to personnel for timely handling. That is, the embodiments of the present disclosure perform a dual industrial control security audit on both the industrial control protocol data and the network behavior data, and the disclosed method can promptly and accurately detect whether a network security event has occurred in the industrial control network, and promptly notify personnel for handling, thereby significantly reducing the risk of the industrial control network being subjected to cyberattacks.

In other embodiments, in addition to performing the dual industrial control security audit on both the industrial control protocol data and the network behavior data, a third audit result can be determined based on the binding status of an IP address and a MAC address, the access relationship between at least two devices, and the devices present in the industrial control network during the target audit time period. By comprehensively analyzing the first audit result, the second audit result, and the third audit result, a security level of a network security event can be evaluated, thereby obtaining a network security evaluation result for the target audit period. Security audits can be performed to determine whether the binding of the IP address and the MAC address has changed, whether the access relationship between the at least two devices has changed, and whether any unknown device has been present in the industrial control network.

In summary, the method provided in the embodiment of the present disclosure determines the protocol rule template corresponding to the industrial control protocol data based on the similarity between the industrial control protocol data and the protocol rule templates of various industrial control protocols in a protocol database; parses the control information of the industrial control protocol data based on the protocol rule template corresponding to the industrial control protocol data; determines the first audit result based on the control information, complete message data, and data area message data of the industrial control protocol data; determines the second audit result based on the statistical features of the network traffic per unit time in the network behavior data, and/or based on differences between the current running program information and the historical running program information in the network behavior data; and evaluates a severity level of network security events based on the first audit result and the second audit result to obtain a network security evaluation result for the target audit time period. By performing dual industrial control security audits on both the industrial control protocol data and the network behavior data, the disclosed method can promptly and accurately detect whether a network security event has occurred in the industrial control network, thereby significantly reducing the risk of the industrial control network being subjected to cyberattacks.

The following is a description of an industrial control audit apparatus based on the Industrial Internet provided in the present disclosure. The industrial control audit apparatus based on the Industrial Internet described below can correspond to the industrial control audit method based on the Industrial Internet described above.

According to any of the above embodiments, FIG. 4 is a schematic diagram of a structure of an industrial control audit apparatus based on the Industrial Internet provided in the present disclosure. As shown in FIG. 4, the apparatus includes:
a data acquisition unit 410, configured to acquire industrial control protocol data and network behavior data within a target audit time period;
a first audit unit 420, configured to determine, based on a similarity between the industrial control protocol data and protocol rule templates of various industrial control protocols in a protocol database, a protocol rule template corresponding to the industrial control protocol data, to parse control information of the industrial control protocol data based on the protocol rule template corresponding to the industrial control protocol data, and to determine a first audit result based on the control information, complete message data, and data area message data of the industrial control protocol data;
a second audit unit 430, configured to determine a second audit result based on statistical features of network traffic per unit time in the network behavior data, and/or based on differences between current running program information and historical running program information in the network behavior data; and
a security evaluation unit 440, configured to evaluate a severity level of network security events based on the first audit result and the second audit result to obtain a network security evaluation result for the target audit time period.

The apparatus provided in the embodiment of the present disclosure determines the protocol rule template corresponding to the industrial control protocol data based on the similarity between the industrial control protocol data and the protocol rule templates of various industrial control protocols in a protocol database; parses the control information of the industrial control protocol data based on the protocol rule template corresponding to the industrial control protocol data; determines the first audit result based on the control information, complete message data, and data area message data of the industrial control protocol data; determines the second audit result based on the statistical features of the network traffic per unit time in the network behavior data, and/or based on differences between the current running program information and the historical running program information in the network behavior data; and evaluates a severity level of network security events based on the first audit result and the second audit result to obtain a network security evaluation result for the target audit time period. By performing dual industrial control security audits on both the industrial control protocol data and the network behavior data, the disclosed apparatus can promptly and accurately detect whether a network security event has occurred in the industrial control network, thereby significantly reducing the risk of the industrial control network being subjected to cyberattacks.

According to any of the above embodiments, the determining a first audit result based on the control information, complete message data, and data area message data of the industrial control protocol data, includes:
determining, based on sample control information of sample industrial control protocol data labeled as normal and the control information of the industrial control protocol data, a control anomaly analysis result of the industrial control protocol data;
performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
determining the first audit result based on the control anomaly analysis result, the complete message anomaly analysis result, and the data area message anomaly analysis result of the industrial control protocol data.

According to any of the above embodiments, the similarity between the industrial control protocol data and the protocol rule template of any type of industrial control protocol in the protocol database is determined based on the following steps:
determining all common subsequences and the longest common subsequence between the industrial control protocol data and the protocol rule template of the any type of industrial control protocol;
determining a difference factor based on sequence length of the longest common subsequence between the industrial control protocol data and the protocol rule template of the any type of industrial control protocol and the sequence lengths of the industrial control protocol data and the protocol rule template of the any type of industrial control protocol;
determining a sequence consistency factor based on a sum of the sequence lengths of all common subsequences between the industrial control protocol data and the protocol rule template of the any type of industrial control protocol, the sequence lengths of the industrial control protocol data and the protocol rule template of the any type of industrial control protocol, and the difference factor;
calculating an edit distance between the industrial control protocol data and the protocol rule template of the any type of industrial control protocol, and determining a sequence similarity factor based on the sequence length of the longest common subsequence between the industrial control protocol data and the protocol rule template of the any type of industrial control protocol and the edit distance between the industrial control protocol data and the protocol rule template of the any type of industrial control protocol; and
determining, based on the sequence consistency factor and the sequence similarity factor, the similarity between the industrial control protocol data and the protocol rule template of the any type of industrial control protocol.

According to any of the above embodiments, the protocol rule templates for various industrial control protocols in the protocol database are constructed based on the following steps:
feature extraction step: extracting textual features of each sample industrial control protocol data in the protocol database, where the textual features of any sample industrial control protocol data are determined based on term frequency and inverse document frequency of each segment in the any sample industrial control protocol data;
clustering step: clustering the sample industrial control protocol data based on a set value of the number of current clusters in combination with the textual features of each sample industrial control protocol data to obtain a plurality of current clusters and to acquire a cluster center of each cluster;
iteration step: performing cluster evaluation on the plurality of the current clusters to obtain a current cluster evaluation value; where if the current cluster evaluation value is greater than a currently optimal evaluation value, updating the current optimal evaluation value based on the current cluster evaluation value, and updating the current optimal clustering cluster and the cluster center of each current optimal clustering cluster based on the plurality of current clusters and their cluster centers; and increasing the set value of the number of the current clusters and repeating the clustering step until the set value of the number of the current clusters reaches a preset value; and
template determination step: determining the protocol rule templates for various industrial control protocols based on the cluster centers of the current optimal clustering clusters.

According to any of the above embodiments, the determining a second audit result based on statistical features of network traffic per unit time in the network behavior data, and/or based on differences between current running program information and historical running program information in the network behavior data, includes:
determining a network traffic anomaly analysis result, based on statistical features of network traffic per unit time in the network behavior data, where the statistical features include a mean, variance, and quantile of the network traffic per unit time; and/or,
determining, based on the current running program information and the historical running program information in a historical time period in the network behavior data, the current running program information that does not match the historical running program information as a suspected the target audit time period and on memory information of the suspected abnormal running program; and
determining the second audit result based on the network traffic anomaly analysis result and/or the running program anomaly analysis result.

According to any of the above embodiments, the apparatus further includes an exception handling unit configured to perform after the determining the second audit result:
issuing, if either the network traffic anomaly analysis result or the running program anomaly analysis result indicates an anomaly, a network security alarm under the condition that power supply and network connection are not interrupted; and issuing, if both the network traffic anomaly analysis result and the running program
anomaly analysis result indicate anomalies, a network security alarm under the condition that the network connection is cut off while the power supply remains uninterrupted.

According to any of the above embodiments, the evaluating a severity level of network security events based on the first audit result and the second audit result to obtain a network security evaluation result for the target audit time period, includes:
determining a third audit result based on the binding status of an IP address and a MAC address, the access relationship between at least two devices, and the devices present in the industrial control network during the target audit time period; and
evaluating a severity level of network security events based on the first audit result, the second audit result, and the third audit result to obtain a network security evaluation result for the target audit time period.

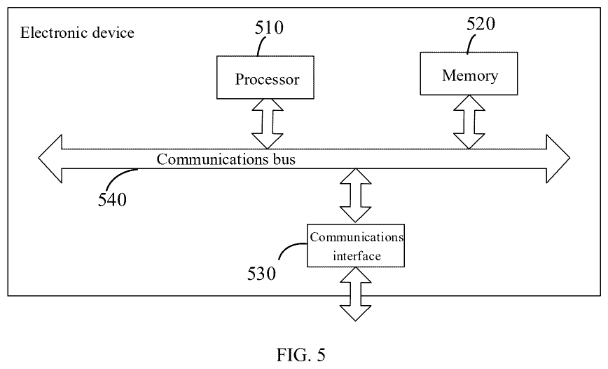

FIG. 5 is a schematic diagram of a structure of an electronic device provided in the present disclosure. As shown in FIG. 5, the electronic device can include: a processor 510, a memory 520, a communications interface 530, and a communications bus 540, where the processor 510, the memory 520, and the communications interface 530 communicate with each other via the communications bus 540. The processor 510 can invoke a logic instruction stored on the memory 520 to execute an industrial control audit method based on the Industrial Internet. The method includes: acquiring industrial control protocol data and network behavior data within a target audit time period; determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; determining a first audit result based on the control information, complete message data, and data area message data of the industrial control protocol data; determining a second audit result based on statistical features of network traffic per unit time in the network behavior data, and/or based on differences between current running program information and historical running program information in the network behavior data; and evaluating a severity level of network security events based on the first audit result and the second audit result to obtain a network security evaluation result for the target audit time period.

In addition, the logic instruction in the above memory 520 can be implemented in a form of a software functional unit, and when sold or used as an independent product, the logic instruction can be stored on a computer-readable storage medium. Based on such an understanding, the technical solution of the present disclosure, in essence, or the part that contributes to the existing art, or the part of the technical solution, can be embodied in a form of a software product. The computer software product is stored on a storage medium and includes several instructions for enabling a computer device (which can be a personal computer, a server, or a network device, and the like.) to execute all or part of the steps of the method described in various embodiments of the present disclosure. The aforementioned storage medium includes: a USB flash drive, a mobile hard disk, read-only memory (ROM), random access memory (RAM), a magnetic disk, an optical disk, or other medium capable of storing program code.

On the other hand, the present disclosure further provides a computer program product. The computer program product includes a computer program stored on a non-transitory computer-readable storage medium, where the computer program includes a program instruction. When the program instruction is executed by a computer, the computer can execute the industrial control audit method based on the Industrial Internet provided by the above methods. The method includes: acquiring industrial control protocol data and network behavior data within a target audit time period; determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; determining a first audit result based on the control information, complete message data, and data area message data of the industrial control protocol data; determining a second audit result based on statistical features of network traffic per unit time in the network behavior data, and/or based on differences between current running program information and historical running program information in the network behavior data; and evaluating a severity level of network security events based on the first audit result and the second audit result to obtain a network security evaluation result for the target audit time period.

In another aspect, the present disclosure further provides a non-transitory computer-readable storage medium storing a computer program. When executed by a processor, the computer program is configured to implement the above industrial control audit methods based on the Industrial Internet. The method includes: acquiring industrial control protocol data and network behavior data within a target audit time period; determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; determining a first audit result based on the control information, complete message data, and data area message data of the industrial control protocol data; determining a second audit result based on statistical features of network traffic per unit time in the network behavior data, and/or based on differences between current running program information and historical running program information in the network behavior data; and evaluating a severity level of network security events based on the first audit result and the second audit result to obtain a network security evaluation result for the target audit time period.

The apparatus embodiments described above are merely illustrative. The units described as separate components may or may not be physically separate, and the components shown as units may or may not be physical units, that is, they may be located in one place or distributed across multiple network units. Some or all of modules can be selected according to actual requirements to achieve the objectives of this embodiment. Those of ordinary skill in the art can understand and implement the embodiments without creative efforts.

From the above descriptions of the embodiments, those skilled in the art can clearly understand that the embodiments can be implemented by means of software in combination with a necessary general-purpose hardware platform, or alternatively, can be implemented entirely through hardware. Based on such understanding, the above technical solution, in essence, or the part that contributes to the existing art, can be embodied in a form of a software product. The computer software product can be stored on a computer-readable storage medium such as ROM/RAM, a magnetic disk, an optical disk, including several instructions for enabling a computer device (which can be a personal computer, a server, or a network device, and the like.) to execute the methods described in the embodiments or in certain parts of the embodiments.

Finally, it should be noted that the above embodiments are only used to illustrate the technical solutions of the present disclosure, and are not intended to limit them. Although the present disclosure has been described in detail with reference to the aforementioned embodiments, those of ordinary skill in the art will appreciate that modifications can still be made to the technical solutions described in the aforementioned embodiments, or equivalents may be substituted for certain technical features. Such modifications or substitutions do not make the essence of the corresponding technical solutions depart from the spirit and scope of the technical solutions of the embodiments of the present disclosure.

### INDUSTRIAL APPLICABILITY

By adopting the above solution, dual industrial control security audits are performed on industrial control protocol data and network behavior data, enabling prompt and accurate detection of whether a network security event has occurred in the industrial control network, thereby significantly reducing the risk of the industrial control network being subjected to cyberattacks.

What is claimed is:

1. An industrial control audit method based on Industrial Internet, comprising:
acquiring industrial control protocol data and network behavior data within a target audit time period;
determining, based on a similarity between the industrial control protocol data and protocol rule templates of various industrial control protocols in a protocol database, a protocol rule template corresponding to the industrial control protocol data; parsing control information of the industrial control protocol data based on the protocol rule template corresponding to the industrial control protocol data; and determining a first audit result based on the control information, complete message data, and data area message data of the industrial control protocol data;
determining a second audit result based on statistical features of network traffic per unit time in the network behavior data, and/or based on differences between current running program information and historical running program information in the network behavior data; and
evaluating a severity level of network security events based on the first audit result and the second audit result to obtain a network security evaluation result for the target audit time period, wherein
a similarity between the industrial control protocol data and the protocol rule template of any type of industrial control protocol in the protocol database is determined based on following steps:
determining all common subsequences and the longest common subsequence between the industrial control protocol data and the protocol rule template of the any type of industrial control protocol;
determining a difference factor based on sequence length of the longest common subsequence between the industrial control protocol data and the protocol rule template of the any type of industrial control protocol and sequence lengths of the industrial control protocol data and the protocol rule template of the any type of industrial control protocol;
determining a sequence consistency factor based on a sum of sequence lengths of all common subsequences between the industrial control protocol data and the protocol rule template of the any type of industrial control protocol, the sequence lengths of the industrial control protocol data and the protocol rule template of the any type of industrial control protocol, and the difference factor;
calculating an edit distance between the industrial control protocol data and the protocol rule template of the any type of industrial control protocol, and determining a sequence similarity factor based on the sequence length of the longest common subsequence between the industrial control protocol data and the protocol rule template of the any type of industrial control protocol and the edit distance between the industrial control protocol data and the protocol rule template of the any type of industrial control protocol; and
determining, based on the sequence consistency factor and the sequence similarity factor, the similarity between the industrial control protocol data and the protocol rule template of the any type of industrial control protocol, wherein
the protocol rule templates for various industrial control protocols in the protocol database are constructed based on following steps:
feature extraction step, comprising extracting textual features of each sample industrial control protocol data in the protocol database, where the textual features of any sample industrial control protocol data are determined based on term frequency and inverse document frequency of each segment in the any sample industrial control protocol data;
clustering step, comprising clustering the sample industrial control protocol data based on a set value of the number of current clusters in combination with the textual features of each sample industrial control protocol data to obtain a plurality of current clusters and to acquire a cluster center of each cluster;
iteration step, comprising performing cluster evaluation on the plurality of current clusters to obtain a current cluster evaluation value; where when the current cluster evaluation value is greater than a currently optimal evaluation value, updating the current optimal evaluation value based on the current cluster evaluation value, and updating a current optimal clustering cluster and a cluster center of each current optimal clustering cluster based on the plurality of current clusters and their cluster centers; and increasing the set value of the number of the current clusters and repeating the clustering step until the set value of the number of the current clusters reaches a preset value; and
template determination step, comprising determining the protocol rule templates for various industrial control protocols based on the cluster centers of the current optimal clustering clusters.

2. The industrial control audit method based on the Industrial Internet according to claim 1, wherein the determining a first audit result based on the control information, complete message data, and data area message data of the industrial control protocol data, comprises:
determining, based on sample control information of sample industrial control protocol data labeled as normal and the control information of the industrial control protocol data, a control anomaly analysis result of the industrial control protocol data;
performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
determining the first audit result based on the control anomaly analysis result, the complete message anomaly analysis result, and the data area message anomaly analysis result of the industrial control protocol data.

3. The industrial control audit method based on the Industrial Internet according to claim 1, wherein the determining a second audit result based on statistical features of network traffic per unit time in the network behavior data, and/or based on differences between current running program information and historical running program information in the network behavior data, comprises:
determining a network traffic anomaly analysis result, based on the statistical features of network traffic per unit time in the network behavior data, where the statistical features comprise a mean, variance, and quantile of the network traffic per unit time; and/or,
determining, based on the current running program information and the historical running program information in a historical time period in the network behavior data, current running program information that does not match the historical running program information as a suspected abnormal running program; and determining a running program anomaly analysis result based on the number of executions of the suspected abnormal running program during each unit time within the target audit time period and on memory information of the suspected abnormal running program; and
determining the second audit result based on the network traffic anomaly analysis result and/or the running program anomaly analysis result.

4. The industrial control audit method based on the Industrial Internet according to claim 3, wherein after the determining a second audit result, the method further comprises:
issuing, when either the network traffic anomaly analysis result or the running program anomaly analysis result indicates an anomaly, a network security alarm under a condition that power supply and network connection are not interrupted; and
issuing, when both the network traffic anomaly analysis result and the running program anomaly analysis result indicate anomalies, a network security alarm under a condition that the network connection is cut off while the power supply remains uninterrupted.

5. The industrial control audit method based on the Industrial Internet according to claim 1, wherein the evaluating a severity level of network security events based on the first audit result and the second audit result to obtain a network security evaluation result for the target audit time period, comprises:
determining a third audit result based on a binding status of an IP address and a MAC address, an access relationship between at least two devices, and devices present in an industrial control network during the target audit time period; and
evaluating the severity level of network security events based on the first audit result, the second audit result, and the third audit result to obtain a network security evaluation result for the target audit time period.

6. The industrial control audit method based on the Industrial Internet according to claim 1, wherein a calculation method for the difference factor is:
$$d = 1 - α \times {L}_{LCS} / ( p + q )$$
where d is the difference factor, L_{LCS} is the sequence length of the longest common subsequence between the industrial control protocol data and the protocol rule template of the any type of industrial control protocol, p is the sequence length of the industrial control protocol data, q is the sequence length of the protocol rule template of the any type of industrial control protocol, and α is a first adjustment factor.

7. The industrial control audit method based on the Industrial Internet according to claim 6, wherein a calculation method for the sequence consistency factor is:
$$suc = β \times d \times Sop ( D , T ) / ( p + q )$$
where suc is the sequence consistency factor, Sop(D, T) is the sum of the sequence lengths of all common subsequences between the industrial control protocol data and the protocol rule template of the any type of industrial control protocol, and β is a second adjustment factor.

8. The industrial control audit method based on the Industrial Internet according to claim 7, wherein a calculation method for the sequence similarity factor is:
$$sos = {L}_{LCS} + ( max ( p , q ) - {L}_{ED} )$$
where sos is the sequence similarity factor, and L_{ED} is the edit distance between the industrial control protocol data and the protocol rule template of the any type of industrial control protocol.

9. The industrial control audit method based on the Industrial Internet according to claim 1, wherein the extracting textual features of each sample industrial control protocol data in the protocol database, comprises:
determining a term frequency of any segment according to a ratio of the number of occurrences of the any segment in the any sample industrial control protocol data to the total number of segments in the any sample industrial control protocol data;
determining an inverse document frequency of the any segment according to a logarithm of a ratio of the total number of the sample industrial control protocol data in the protocol database to the number of sample industrial control protocol data containing the any segment in the protocol database;
determining a feature value of the any segment according to a product of the term frequency of the any segment and the inverse document frequency of the any segment; and
determining the textual features of the any sample industrial control protocol data based on a vector composed of feature values of all segments in the any sample industrial control protocol data.

10. The industrial control audit method based on the Industrial Internet according to claim 1, further comprising:
determining the first audit result as abnormal when the similarities between the industrial control protocol data and the protocol rule templates of various industrial control protocols in the protocol database are all less than a preset threshold.

11. The industrial control audit method based on the Industrial Internet according to claim 1, wherein the determining, based on sample control information of sample industrial control protocol data labeled as normal and the control information of the industrial control protocol data, a control anomaly analysis result of the industrial control protocol data, comprises:
determining the control anomaly analysis result as abnormal when the control information of the industrial control protocol data is not comprised in the sample control information of the sample industrial control protocol data labeled as normal.

12. An industrial control audit apparatus based on Industrial Internet, comprising:
a data acquisition unit, configured to acquire industrial control protocol data and network behavior data within a target audit time period;
a first audit unit, configured to determine, based on a similarity between the industrial control protocol data and protocol rule templates of various industrial control protocols in a protocol database, a protocol rule template corresponding to the industrial control protocol data, to parse control information of the industrial control protocol data based on the protocol rule template corresponding to the industrial control protocol data, and to determine a first audit result based on the control information, complete message data, and data area message data of the industrial control protocol data;
a second audit unit, configured to determine a second audit result based on statistical features of network traffic per unit time in the network behavior data, and/or based on differences between current running program information and historical running program information in the network behavior data; and
a security evaluation unit, configured to evaluate a severity level of network security events based on the first audit result and the second audit result to obtain a network security evaluation result for the target audit time period;
a similarity between the industrial control protocol data and a protocol rule template of any type of industrial control protocol in the protocol database is determined based on following steps:
determining all common subsequences and the longest common subsequence between the industrial control protocol data and the protocol rule template of the any type of industrial control protocol;
determining a difference factor based on sequence length of the longest common subsequence between the industrial control protocol data and the protocol rule template of the any type of industrial control protocol and the sequence lengths of the industrial control protocol data and the protocol rule template of the any type of industrial control protocol;
determining a sequence consistency factor based on a sum of sequence lengths of all common subsequences between the industrial control protocol data and the protocol rule template of the any type of industrial control protocol, the sequence lengths of the industrial control protocol data and the protocol rule template of the any type of industrial control protocol, and the difference factor;
calculating an edit distance between the industrial control protocol data and the protocol rule template of the any type of industrial control protocol, and determining a sequence similarity factor based on the sequence length of the longest common subsequence between the industrial control protocol data and the protocol rule template of the any type of industrial control protocol and the edit distance between the industrial control protocol data and the protocol rule template of the any type of industrial control protocol; and
determining, based on the sequence consistency factor and the sequence similarity factor, the similarity between the industrial control protocol data and the protocol rule template of the any type of industrial control protocol, wherein
the protocol rule templates for various industrial control protocols in the protocol database are constructed based on following steps:
feature extraction step, comprising extracting textual features of each sample industrial control protocol data in the protocol database, where the textual features of any sample industrial control protocol data are determined based on term frequency and inverse document frequency of each segment in the any sample industrial control protocol data;
clustering step, comprising clustering the sample industrial control protocol data based on a set value of the number of current clusters in combination with the textual features of each sample industrial control protocol data to obtain a plurality of current clusters and to acquire a cluster center of each cluster;
iteration step, comprising performing cluster evaluation on the plurality of current clusters to obtain a current cluster evaluation value; where when the current cluster evaluation value is greater than a currently optimal evaluation value, updating the current optimal evaluation value based on the current cluster evaluation value, and updating a current optimal clustering cluster and the cluster center of each current optimal clustering cluster based on the plurality of current clusters and their cluster centers; and increasing the set value of the number of the current clusters and repeating the clustering step until the set value of the number of the current clusters reaches a preset value; and
template determination step, comprising determining the protocol rule templates for various industrial control protocols based on the cluster centers of the current optimal clustering clusters.

13. An electronic device, comprising a memory, a processor, and a computer program stored on the memory and executable by the processor, wherein the processor, when executing the computer program, implements the industrial control audit method based on the Industrial Internet according to claim 1.

14. A non-transitory computer-readable storage medium, storing a computer program, wherein the computer program, when executed by a processor, implements the industrial control audit method based on the Industrial Internet according to claim 1.

15. The electronic device according to claim 13, wherein the determining a first audit result based on the control information, complete message data, and data area message data of the industrial control protocol data, comprises:
determining, based on sample control information of sample industrial control protocol data labeled as normal and the control information of the industrial control protocol data, a control anomaly analysis result of the industrial control protocol data;
performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
determining the first audit result based on the control anomaly analysis result, the complete message anomaly analysis result, and the data area message anomaly analysis result of the industrial control protocol data.

16. The electronic device according to claim 13, wherein the determining a second audit result based on statistical features of network traffic per unit time in the network behavior data, and/or based on differences between current running program information and historical running program information in the network behavior data, comprises:
determining a network traffic anomaly analysis result, based on the statistical features of network traffic per unit time in the network behavior data, where the statistical features comprise a mean, variance, and quantile of the network traffic per unit time; and/or,
determining, based on the current running program information and the historical running program information in a historical time period in the network behavior data, current running program information that does not match the historical running program information as a suspected abnormal running program; and determining a running program anomaly analysis result based on the number of executions of the suspected abnormal running program during each unit time within the target audit time period and on memory information of the suspected abnormal running program; and
determining the second audit result based on the network traffic anomaly analysis result and/or the running program anomaly analysis result.

17. The electronic device according to claim 16, further comprising, after the determining a second audit result:
issuing, when either the network traffic anomaly analysis result or the running program anomaly analysis result indicates an anomaly, a network security alarm under a condition that power supply and network connection are not interrupted; and
issuing, when both the network traffic anomaly analysis result and the running program anomaly analysis result indicate anomalies, a network security alarm under a condition that the network connection is cut off while the power supply remains uninterrupted.

18. The non-transitory computer-readable storage medium according to claim 14, wherein the determining a first audit result based on the control information, complete message data, and data area message data of the industrial control protocol data, comprises:
determining, based on sample control information of sample industrial control protocol data labeled as normal and the control information of the industrial control protocol data, a control anomaly analysis result of the industrial control protocol data;
performing, based on a trained global anomaly analysis model, anomaly analysis on the complete message data of the industrial control protocol data to obtain a complete message anomaly analysis result of the industrial control protocol data, where the global anomaly analysis model is trained based on sample complete message data of sample industrial control protocol data and labels of the sample industrial control protocol data;
performing, based on a trained local anomaly analysis model, anomaly analysis on the data area message data of the industrial control protocol data to obtain a data area message anomaly analysis result of the industrial control protocol data, where the local anomaly analysis model is trained based on sample data area message data of sample industrial control protocol data and labels of the sample industrial control protocol data; and
determining the first audit result based on the control anomaly analysis result, the complete message anomaly analysis result, and the data area message anomaly analysis result of the industrial control protocol data.

19. The non-transitory computer-readable storage medium according to claim 14, wherein the determining a second audit result based on statistical features of network traffic per unit time in the network behavior data, and/or based on differences between current running program information and historical running program information in the network behavior data, comprises:
determining a network traffic anomaly analysis result, based on the statistical features of network traffic per unit time in the network behavior data, where the statistical features comprise a mean, variance, and quantile of the network traffic per unit time; and/or,
determining, based on the current running program information and the historical running program information in a historical time period in the network behavior data, current running program information that does not match the historical running program information as a suspected the target audit time period and on memory information of the suspected abnormal running program; and
determining the second audit result based on the network traffic anomaly analysis result and/or the running program anomaly analysis result.

20. The non-transitory computer-readable storage medium according to claim 19, further comprising, after the determining a second audit result:
issuing, when either the network traffic anomaly analysis result or the running program anomaly analysis result indicates an anomaly, a network security alarm under a condition that power supply and network connection are not interrupted; and
issuing, when both the network traffic anomaly analysis result and the running program anomaly analysis result indicate anomalies, a network security alarm under a condition that the network connection is cut off while the power supply remains uninterrupted.
